(19) United States
(12) Patent Application Publication
(10) Pub. No.: US 2010/0229470 A1
(43) Pub. Date: Sep. 16, 2010

(54) VEHICLE DOOR

(76) Inventor: Lars Wikstrom, Lulea (SE)

Correspondence Address: MARK P. STONE;ATTORNEY AT LAW, 50 BROADWAY, HAWTHORNE, NY, 10532, US

(21) Appl. No.: 12/449,338

(22) PCT Filed: Jan. 25, 2008
(86) PCT No.: PCT/SE2008/000061

§ 371 Date: May 24, 2010

(30) Foreign Application Priority Data
Feb. 5, 2007 (SE) 0700267-8

(51) Int. Cl. B60J 5/04

(52) U.S. Cl. 49/394

(57) ABSTRACT

A vehicle door comprises an outer module (10) which itself comprises a loadbearing doorframe (12-16) made of high-strength sheet steel which has a lateral collision protection (16) and bears the hinges of the door, and an outer panel (17) fastened in the doorframe in such a way that it is closely adjacent to the lateral collision protection, and an inner module which comprises an inner panel, a window surround, a window winding device and a door lock, the inner module constituting a closed box (26) against the doorframe and being screwed firmly to the doorframe in such a way that it is removable as a unit while the doorframe is attached to the bodywork by its hinges. The window surround (27) of the inner panel comprises a first profile (28) which is open outwards and is otherwise formed integrally with the inner panel, and a second open profile (29) which is fastened to the first profile in such a way that the window surround is provided with a closed profile.

### TECHNICAL FIELD

The present invention relates to a vehicle door comprising an outer module which itself comprises a loadbearing doorframe made of high-strength sheet steel which has a lateral collision protection and bears the hinges of the door, and an outer panel fastened in the doorframe in such a way that it is closely adjacent to the lateral collision protection, and an inner module which comprises an inner panel, a window surround, a window winding device and a door lock, said inner module constituting a box against the doorframe and being screwed firmly to the doorframe in such a way that it is removable as a unit while the doorframe remains attached to the bodywork by its hinges.

WO2004/014681 refers to such a door which has an outer doorframe and an inner module comprising a structure made of steel members to which the window frame, the internal parts of the door and an inner panel made of plastic are fitted before the inner module is screwed firmly into the doorframe. The inner module can, when necessary, be removed and be subsequently refitted.

### OBJECT AND BRIEF DESCRIPTION OF THE INVENTION

An object of the invention is to simplify the manufacture of a door of the kind indicated in the introduction and to make an unbroken seal possible round the door despite the inner module of the door being easy to remove and refit.

This object is achieved by the box being made of cold-formed sheet steel and by the window surround comprising a first profile which is open outwards and formed integrally with the box, and a second open profile which is fastened to the first profile in such a way that the window surround is provided with a closed profile.

### BRIEF DESCRIPTION OF THE DRAWINGS DEPICTING A VEHICLE DOOR AS AN EXAMPLE OF THE INVENTION

FIG. 1 depicts in perspective as seen obliquely from in front/from inside the two separated main elements of the vehicle door.

FIG. 2 depicts the same elements as seen obliquely from behind/from inside.

FIG. 3 depicts the door assembled.

FIG. 4 is a section along the line 4-4 in FIG. 3 in an enlarged view.

FIG. 5 depicts the inside of one of the main elements.

FIG. 6 is a vertical section through the door depicted in FIG. 3 but without the door's window surround and the internal parts of the door.

### DETAILED DESCRIPTION OF EMBODIMENT EXAMPLE DEPICTED

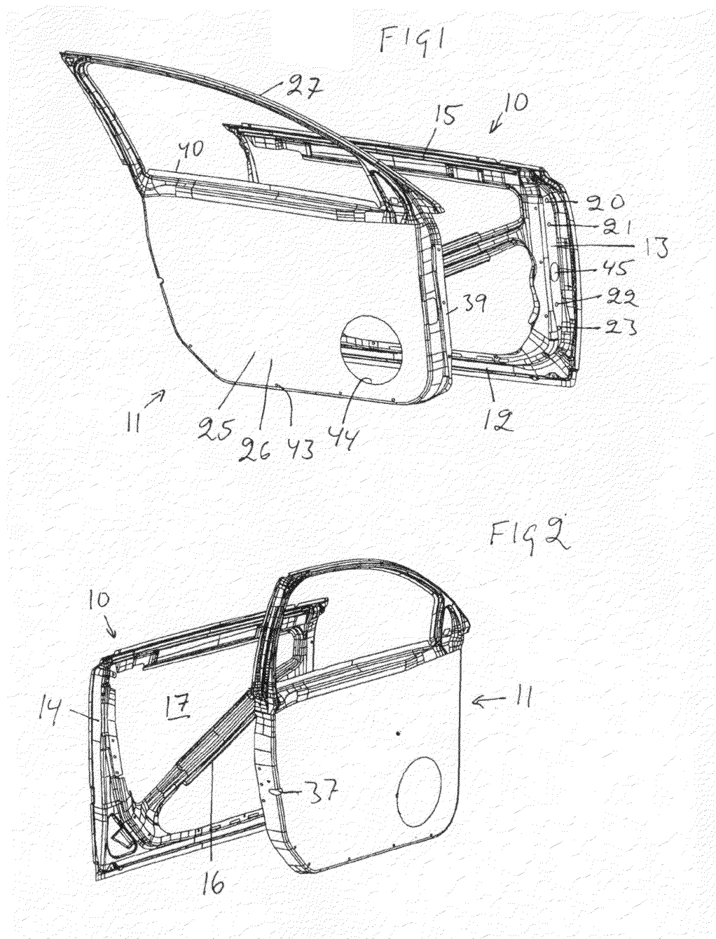

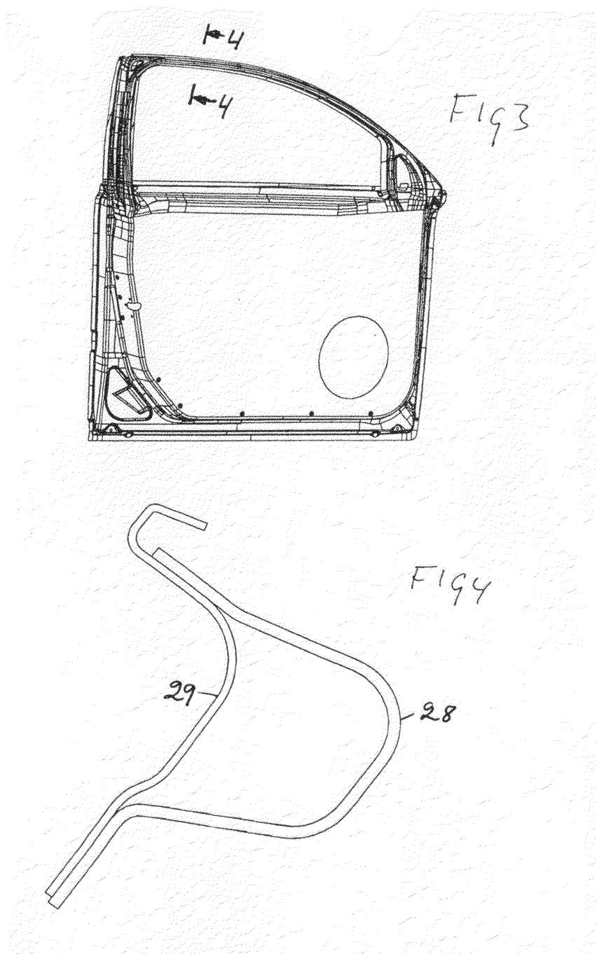

The vehicle door depicted in the drawings is a front side-door and comprises, as best illustrated in FIGS. 1 and 2, an outer module 10 and an inner module 11. The outer module comprises an annular loadbearing frame made of high-strength steel which has a lower member 12, a forward member 13, a rear member 14, a window member 15 and a side collision protection in the form of a member 16 which slopes rearwards from the region of the fastening of the upper forward hinge to the angle between the rear member 14 and the lower member 12. The members of the annular frame are of modified hat profile with the crown pointing inwards, and an outer panel 17 is folded and bonded round the outer flange of the hat profile so that it is adjacent to the collision protection and is stabilised with mastic in between. The press-hardening process is used with advantage to hot-form and harden in a single step a hardenable planar steel sheet in a cooled pair of tools in order to constitute the frame.

The forward member has fastening holes 20,21 and 22,23 respectively with, welded on their inside, nuts in which the respective upper and lower hinges of the door are firmly screwed. The hinges are not depicted, only their brackets.

The main component of the inner module 11 is an inner panel 25 made of sheet steel cold-formed in such a way that it has a lower portion 26 which fits in a boxlike manner against the frame 12-15 and accommodates an integrated window surround 27. The portion of the window surround 27 thus formed has a profile 28 which is open outwards, but the window surround 27 is provided with a closed profile by means of an outer profile 29 which is welded to the profile 28 as illustrated in FIG. 4. The outer profile 29 may be annular and have a horizontal portion 40 which is welded to the main element of the inner panel, as illustrated in FIG. 6, thereby constituting a horizontally closed profile which provides rigidity and can absorb axial forces. At the upper edge, the outer profile 29 has a U-shaped profile 41 in which may be fitted an extra seal additional to the seal which is fitted to the bodywork and runs continuously round the door aperture but may alternatively be fitted to the door.

The yield point of the steel of the doorframe 12-16 is at least four times greater than that of the inner panel and preferably five times as great. The inner panel may for example have a yield point of about 200 MPa, while the doorframe may have a yield point of 1100 MPa.

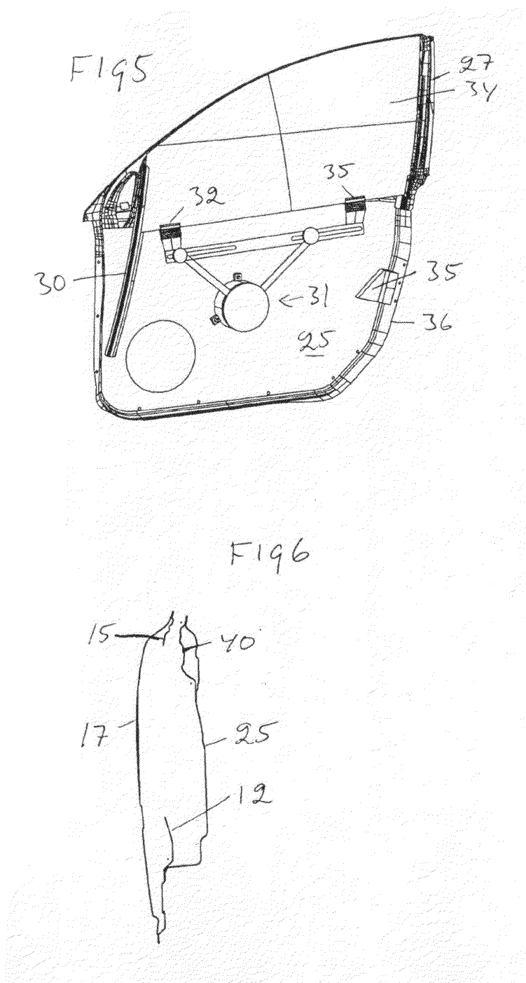

FIG. 5 depicts the internals of the inner panel 25. A guide 30 for the window is welded to the inner panel 25, and a motorised winding device 31 for the window has retainers 32,33 for the windowpane 34. The winding device is fitted by screws directly in the inner panel, and the door lock 35 is screwed firmly at the rear end 36 of the inner panel 25. The bodywork latch clamp protrudes in through the hole 37 to the lock when the door is closed.

The inner panel 25 is adapted to the frame, and the frame has a number of nuts welded to it by which the inner panel can be screwed firmly to the frame so that it seals against the frame. The forward end 38 of the inner panel has a flange 39 with holes for screws which are screwed into corresponding weld nuts on the frame. The frame rear member 14 has a turned-up flange 42 with weld nuts, and the rear end 36 of the inner panel has corresponding holes for screws. The lower portion of the inner panel has a number of holes 43 for long screws which are screwed into corresponding weld nuts in the frame lower member 12.

The internal parts of the door are fitted to the inner panel to constitute the inner module 11 before the inner module is fitted. The inner panel 25, i.e. the whole inner module 11, is thereafter screwed firmly to the doorframe. The inner panel is boxlike and seals directly against the frame on three sides, and also, at the top edge, with a suitable seal against the windowpane 34. On the outside of the window, the inner module 11 seals against the window member 15 of the frame by the window member having a suitable seal against the pane. No seals are depicted.

If the internal parts of the doors need repairing, it is easy to unscrew the inner panel 25, i.e. the whole inner module 11, and equally easy thereafter to refit it. The inner panel has a hole 44 for a loudspeaker, and when the loudspeaker is fitted in the inner panel and a hole 45 for cable lead-ins has been sealed, the inner panel 25 and the frame 12-15 form an enclosed space. It is possible for the motor for the window winding device to protrude through a sealed hole in the inner panel if a motor which tolerates the damp environment within the door is not used. The motor protruding through the inner panel may be covered by upholstery fitted to the inner panel.

When a seal is fitted round the bodywork door aperture, it is possible to have an unbroken seal against the inner panel 25 of the door despite the whole inner module 11 being easy to remove from the outer module 10 while the outer module remains suspended on the bodywork.

1. A vehicle door comprising:
an outer module (10) which comprises a loadbearing doorframe (12-16) made of high-strength sheet steel which has a lateral collision protection (16) and bears the hinges of the door, and an outer panel (17) fastened in the doorframe in such a way that it is closely adjacent to the lateral collision protection, and
an inner module (11) which comprises an inner panel (25), a window surround (27), a window winding device (31) and a door lock (35), the inner panel constituting a box (26) against the doorframe and being screwed firmly to the doorframe in such a way that it is removable as a unit while the doorframe remains attached to the bodywork by its hinges,
characterised in that
the box (26) is made of cold-formed sheet steel and the window surround (27) comprises a first profile (28) which is open outwards and intergral with the box, and a second open profile (29) which is fastened to the first profile in such a way that the window surround is provided with a closed profile.

2. A vehicle door according to claim 1, characterised in that the doorframe (12-16) is made by press-hardening.

3. A vehicle door according to claim 1, characterised in that the yield point of the doorframe (12-16) is at least four times greater than yield point of the inner panel (25).

4. A vehicle door according to claim 3, characterised in that the yield point of the doorframe (12-16) is at least five times greater than yield point of the inner panel (25).

5. A vehicle door according to claim 1, characterised in that said box (26) and said window surround (27) are formed simultaneously in a single procedure.

6. A vehicle door according to claim 5, characterised in that the doorframe (12-16) is made by press-hardening.

7. A vehicle door according to claim 2, characterised in that the yield point of the doorframe (12-16) is at least four times greater than yield point of the inner panel (25).

8. A vehicle door according to claim 5, characterised in that the yield point of the doorframe (12-16) is at least four times greater than yield point of the inner panel (25).

9. A vehicle door according to claim 7, characterised in that the yield point of the doorframe (12-16) is at least five times greater than yield point of the inner panel (25).

10. A vehicle door according to claim 5, characterised in that the yield point of the doorframe (12-16) is at least five times greater than yield point of the inner panel (25).
